(19) United States
(12) Patent Application Publication
(10) Pub. No.: US 2021/0042735 A1
(43) Pub. Date: Feb. 11, 2021

(54) SYSTEM AND METHOD FOR CONTROLLING AN APPLICATION PROGRAMMING INTERFACE ENDPOINT FOR TRANSFERRING FUNDS

(71) Applicant: PAYPAL, INC., San Jose, CA (US)

(72) Inventors: Amin Majidi, Vancouver BC (CA); Harnek Singh Randhawa, Surrey (CA)

(73) Assignee: PAYPAL, INC.

(21) Appl. No.: 16/532,480

(22) Filed: Aug. 6, 2019

(51) Int. Cl. G06Q 20/36; G06Q 20/02; G06Q 20/38; G06F 9/54

(52) U.S. Cl. CPC G06Q 20/3672; G06F 9/541; G06Q 20/381; G06Q 20/027

(57) ABSTRACT

A system and method for controlling anomalous access to tables is described. A call including a source token and a destination token is received from a caller. A first type of token and a first type of wallet corresponding to the source token are identified. A second type of token and a second type of wallet corresponding to the destination token are further identified. A transaction is determined based on the first type of token, the first type of wallet, the second type of token, and the second type of wallet. A response quote is sent to the caller. The response quote includes details about the transaction and a request for confirmation.

### TECHNICAL FIELD

The subject technology generally relates to transferring funds and more particularly, relates to a system and method for controlling an application programming interface (API) endpoint for transferring funds.

### BACKGROUND

When building software applications, it is often the goal to create the most flexible and streamlined solution possible. In the world of payment transfers, the transaction of funds has become increasingly more complex as the number of types of accounts and corresponding transactions has increased. There are now a variety of different forms of transfers between the different accounts. As such, application programming interfaces (APIs) that handle funds transfers have become increasingly more complex.

As these APIs become more complex, so does the integration with clients. Typically, multiple types of transactions require multiple types of endpoints to be provided by an API. And as the number of endpoints grow, client integration may become unwieldly. As such, there needs to be a way to enhance the fund transfer process so that the API can be streamlined.

### SUMMARY

According to various aspects of the subject technology, a system for controlling an API endpoint for transferring funds is provided. A call including a source token and a destination token is received from a caller. A first type of token and a first type of wallet corresponding to the source token are identified. A second type of token and a second type of wallet corresponding to the destination token are further identified. A transaction is determined based on the first type of token, the first type of wallet, the second type of token, and the second type of wallet. A response quote is sent to the caller. The response quote includes details about the transaction and a request for confirmation.

According to various aspects of the subject technology, a method for controlling an API endpoint for transferring funds is provided. A call including a source token and a destination token is received from a caller. A first type of token and a first type of wallet corresponding to the source token are identified. A second type of token and a second type of wallet corresponding to the destination token are further identified. A corresponding transaction is determined based on the first type of token, the first type of wallet, the second type of token, and the second type of wallet. A validation is performed based the transaction and at least one of the source amount and the source currency or the destination amount and the destination currency. A response quote is sent to the caller. The response quote includes details about the transaction and a request for confirmation.

According to various aspects of the subject technology, a non-transitory machine-readable medium having stored thereon machine-readable instructions executable for controlling an API endpoint for transferring funds is provided. A call including a source token and a destination token is received from a caller. A first type of token and a first type of wallet corresponding to the source token are identified. A second type of token and a second type of wallet corresponding to the destination token are further identified. A corresponding transaction is determined based on the first type of token, the first type of wallet, the second type of token, and the second type of wallet. A validation is performed based the transaction and at least one of the source amount and the source currency or the destination amount and the destination currency. A response quote is sent to the caller. The response quote includes details about the transaction and a request for confirmation.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an exemplary computing system on which the control of an API endpoint for transferring funds may be performed.

FIG. 2 is a block diagram of an exemplary computer system suitable for implementing one or more devices of the computing system in FIG. 1.

FIG. 3 illustrates an exemplary process 300 for controlling an API endpoint for transferring funds.

FIG. 4 provides a graphical depiction of a transfer endpoint API that orchestrates instructions between a caller and multiple processors.

FIG. 5 provides a breakdown of the components of a request call and a corresponding response quote.

### DETAILED DESCRIPTION

APIs have become cornerstones to computer programming as they provide communication between various computing components. APIs are used to facilitate computer program development by providing building blocks from which the computer programs may be constructed. As the functionality of computer programs become more complex, APIs have likewise increased in complexity to keep pace.

Today, participants in online marketplaces may use a variety of wallets to engage in a variety transactions. As such, the funds transfer space has grown in sophistication. For example, online marketplaces (e.g., Etsy, Inc.) provide virtual space for a variety of merchants to sell to a broad range of consumers. This configuration of merchants selling to consumers via a hosted online marketplace that allows for a wide range of payment options may require more complex platforms on which the transactions are to be handled.

APIs are a commonly used tool for integrating payment platforms with clients (i.e., merchants). By providing building blocks, APIs offer clients some amount of modularity with which to develop. As functionalities provided by a client grow, however, so do the API building blocks (e.g., the number of endpoints). One shortcoming of growing the API in terms of the number of endpoints offered is that it creates more friction during integration. To address is issue, an API with a single endpoint that can handle a variety of transactions through the use of tokens is proposed.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

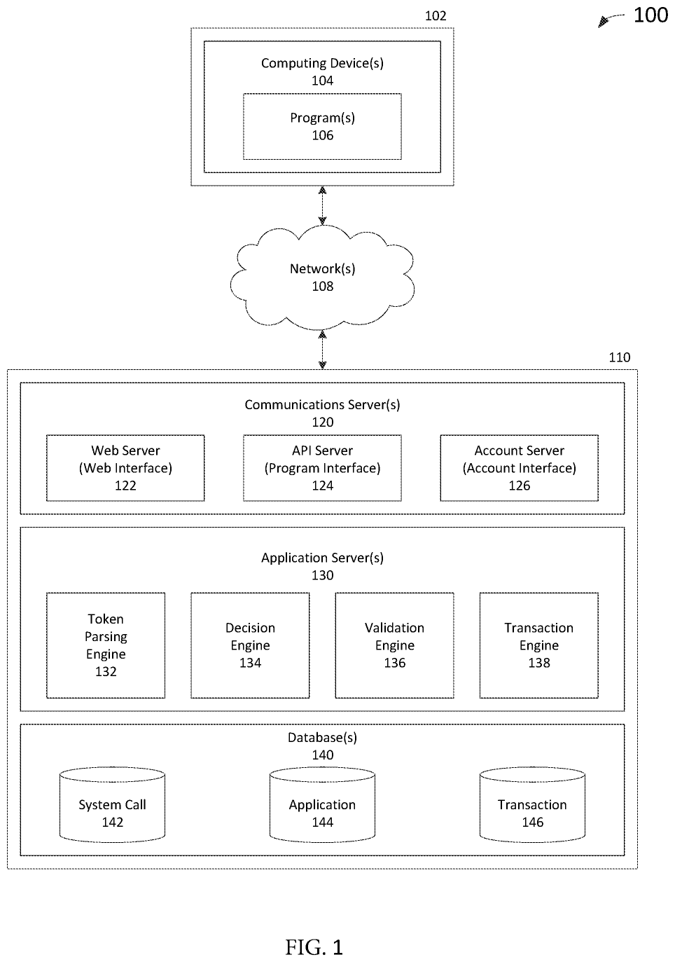

FIG. 1 is a block diagram of an exemplary computing system on which the control of an API endpoint for transferring funds may be performed. As shown, a computing system 100 may comprise or implement a plurality of servers, devices, and/or software components that operate to perform various methodologies in accordance with the described embodiments. Exemplary servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more clients 102 comprising or employing one or more client devices 104, such as a laptop, a mobile computing device, a tablet, a personal computer, a wearable device, and/or any other computing device having computing and/or communications capabilities in accordance with the described embodiments. Client devices 104 may also include a cellular telephone, smart phone, electronic wearable device (e.g., smart watch, virtual reality headset), or other similar mobile devices that a user may carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all of the functionalities and/or processes discussed below.

As shown, client devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between client devices 104 and the network-based system 110 may be sent and received over one or more networks 108 such as the Internet, a WAN, a WWAN, a WLAN, a mobile telephone network, a landline telephone network, personal area network, as well as other suitable networks. For example, client devices 104 may communicate with network-based system 110 over the Internet or other suitable WAN by sending and or receiving information via interaction with a website, e-mail, IM session, and/or video messaging session. Any of a wide variety of suitable communication types between client devices 104 and system 110 may take place, as will be readily appreciated. In particular, wireless communications of any suitable form (e.g., Bluetooth, near-field communication, etc.) may take place between client device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services such as tools for verifying URLs based on information collected about customers. Application servers 130 may include multiple servers and/or components. For example, application servers 130 may include a token parsing engine 132, decision engine 134, validation engine 136, and/or transaction engine 138. These servers and/or components, which may be in addition to other servers, may be structured and arranged to control an API endpoint for transferring funds.

Application servers 130, in turn, may be coupled to and capable of accessing one or more databases 140 including system call database 142, application database 144, and/or transaction database 146. Databases 140 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

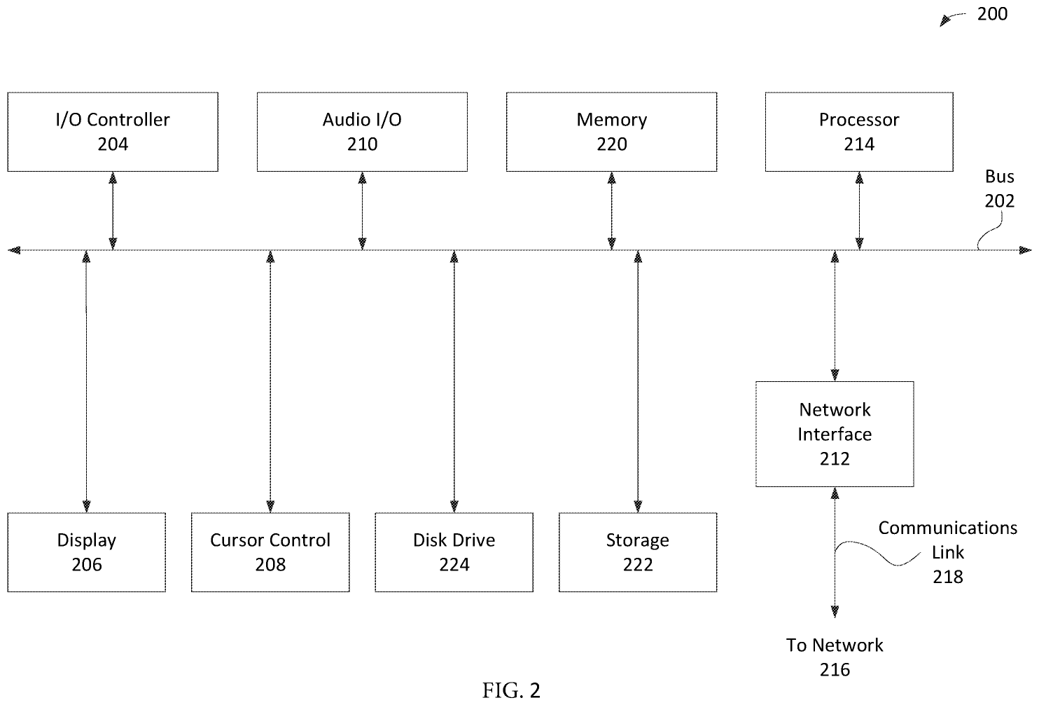

FIG. 2 illustrates an exemplary computer system 200 in block diagram format suitable for implementing on one or more devices of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio.

A transceiver or network interface 212 transmits and receives signals between computer system 200 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

One technique that may be employed to detect anomalous access to tables is to utilize access patterns of both users and tables. By taking into account all users and tables, usage behavior of all users and tables may be learned. Information may further be gleaned from users' relationships with one another. Since the proposed method is not only looking at query-query similarities but also user-user similarities, account users that work in teams or groups are automatically taken into account because they are most likely to execute similar queries.

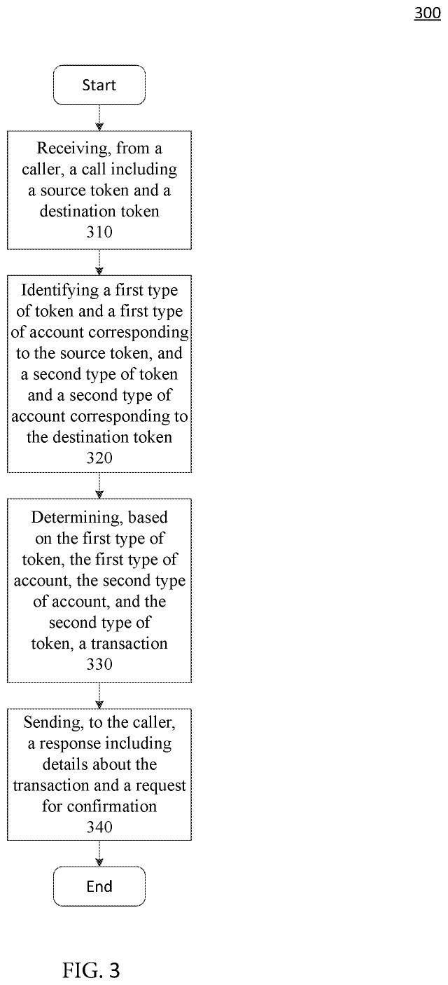

FIG. 3 illustrates an exemplary process 300 for controlling an API endpoint for transferring funds. In step 310, a call for executing a transaction is received from a caller. The call may include a source token and a destination token. Furthermore, the tokens may be designated based on the type of transaction that is to be executed. In an exemplary embodiment, the designations for the token may include, but are not limited to, a user token, an account token, and a transfer method token. User tokens are assigned to transactions that involve consumer wallets, account tokens are assigned to transactions that involve merchant wallets, and transfer method tokens are assigned to transaction that involve external accounts.

In some embodiments, the first three letters of the token provide an indication as to the type of the token. For example, a user token is indicated by a token that starts with “usr,” an account token is indicated by a token that starts with “act,” and a transfer method token is indicated by a token that starts with “trm.” These headers are exemplary only. In other words, in alternative embodiments, the type of token may be indicated by any number of characters at any designated location of the token, so long as the characters are identifiable.

Adding an additional layer of granularity, account tokens, which may also be called satellite wallets, include three subcategories: merchant wallets, funding wallets, and pending wallets. Merchant wallets are used by clients to collect and hold funds from payees. An example of funds collected from payees is the spendback transfer, where the payee may pay for wholesale orders directly from their account to the merchant. For example, in a direct sales model, a payee earns commission from the merchant by selling products supplied by the merchant. A portion of these funds (i.e., commission paid to the payee) may subsequently be transferred back to the merchant by the payee to acquire additional inventory to sell. This transaction is considered a spendback. Funding wallets are used by clients to disburse funds to payees. As indicated above, commission paid by the merchant to the payee in the direct sales model is an example of a use of a funding wallet.

Lastly, pending wallets are intermediary wallets that hold funds until the funds are cleared. Such clearances may be due to waiting for a receiving account to be created, waiting until certain regulations are met, etc. As such, pending wallets are generally not used as part of a source token.

With regards to transfer method tokens, there are two subcategories. The first is a traditional bank account. The second is the prepaid card. Both the bank account and the prepaid card are considered external accounts as they are destinations for cash outs. Additionally, they can be sources for direct debits. The accounts to be used are determined by the tokens. Every account is uniquely identified by a token.

In step 320, a first type of token and a first type of account corresponding to the source token are identified. Additionally, a second type of token and a second type of account corresponding to the destination token are identified. As indicated above, the tokens may be user tokens, account tokens, and transfer method tokens, and the accounts may include consumer wallets, funding wallets, merchant wallets, pending wallets, prepaid cards and bank accounts. Once the type of token and type of account has been identified for each of the source and destination tokens, a determination of a transaction is made based on that information in step 330.

For example, a transaction that involves a user token as a source token and an account token as the destination token indicates a merchant payment. Further inspection of the source token indicates that the account/satellite token is a merchant token. Based on this information, it may be determined that this is a spendback transaction. Alternatively, if the account/satellite token is a funding token, then the system may determine this as some sort of a reverse transaction, as funding wallets are typically used to disburse funds and not to received funds.

Once a determination as to what kind of transaction is being requested, a response including details about the transaction and including a request for confirmation is sent back to the caller as a quote object in step 340. The purpose of the response is to have the caller confirm the transaction. In other words, the system has determined, based on the two tokens and identity of the wallets, what kind of transaction it believes is being called for. However, the system will still require that the caller approves of the transaction in order to book the request. Once booked, the transaction is scheduled to the proper processor.

In some embodiments, the quote object has a predefined expiration. If the response quote that's sent back to the caller is not committed to within, for example, a 90 second timeframe, a job running in the background will clean the quote up, at which point the caller will no longer be able to commit to it. This expiration timeframe is instituted to allow a caller enough time to review the information in a response before confirming, but not so much time that exchange rates might have a chance to fluctuate significantly, thereby creating an element of risk.

In an alternative embodiment, the expiration may be dynamic. For example, if a particular currency that's being exchanged has been determined to be highly volatile, the system may reduce the expiration time to further protect from such volatility. Additionally, the expiration timeframe may be a function of the complexity of the transaction as reflected in the response. That is, the more information (e.g., exchange rates, fees, number of currencies being transacted, etc.) the response may contain, the longer the expiration time may be.

In a typical setup, the above-described process would require an API to have multiple endpoints to execute the various transactions. However, since the types of tokens along with the types of wallets may be determined from the source and destination tokens, only a single endpoint is needed. That is, once the type of transaction is determined based on the information derived from the tokens, the API may schedule the transaction to the appropriate processor, thereby negating the need for a separate endpoint for each type of transaction. The benefit of having a single endpoint is that client would not need to implement different endpoints during integration, thus reducing some friction.

In some embodiments, some combination of source and destination amounts and source and destination currencies may be provided with the call by the caller. The amount defines how much funds is to be transacted (e.g., either sent or received). Likewise, the currency dictates what type of currency is to be sent and/or received. The indication of a specific currency may also implicate foreign exchange where funds in one currency must be converted into another currency for the transaction to be completed. In the instances where multiple currencies are involved, the system will check exchange rates and provide details about the exchange rate and fees in the response quote. Example of how transactions that involve the exchange of currencies are handled will be described in further details below.

In some embodiments, validations checks must be satisfied before a new process may be engaged. That is, once the intended transaction is determined via the source and destination tokens, validation is performed for the particular transaction (i.e., use case) that corresponds to the intended transaction. The validation checks may be run on a combination of the provided information. For example, source and destination amounts and currencies may not be applicable for all use cases. Thus, if a call overspecifies information and/or the information is determined to be inconsistent with the intended transaction, an error will be returned. For instance, a call specifying an amount that's greater than what's available in an account will result in an error. Additionally, if a destination currency is designated for a wallet that cannot accept that currency, an error may also be generated.

In another example of validation, a spendback transaction should not have a source amount specified because a merchant provides to a customer an amount owed for the transaction. In other words, a consumer cannot dictate what he would like to pay at checkout because that figure is fixed by the merchant. Consequently, if the intended transaction is a spendback, and a source amount is indicated by a consumer, then an error will be returned. In some embodiments, once the use case is identified, the call is sent to a validation service that handles the validation step. The different rules that apply to each of the use cases is maintained in the service layer. Once a process is validated, it's passed on to the appropriate processor.

In some embodiments, webhook may be integrated to provide transaction status. Since transactions aren't completed immediately, webhook may be used to provide a notification for when a transaction is completed, or in some cases, declined. For example, webhook may send out a notification once a transaction has cleared.

A series of transaction examples are provided below to fully demonstrate the capabilities of the transfer endpoint API. These examples are for illustration purposes only and should not be taken as limiting the scope of the subject technology. Additional transaction embodiments utilizing similar or the same underlying functionalities may be contemplated by a person of ordinary skill in the art. For example, the number of tokens and/or wallets may grow, thereby increasing the number of types of transactions. While the exemplary embodiments described herein only utilizes three different tokens that are associated with six different wallets/accounts, there's no reason why those numbers cannot be increased to cover a broader range of transactions, as long as the transaction can be uniquely identified. Even if a transaction cannot be uniquely identified after identifying the source and destination tokens, validation of additional fields can be performed to further narrow down the possible transaction until there is only one.

### Example 1—Card to Funding Wallet

In a first example, a source token is a transfer method token corresponding to a prepaid card, and a destination token is an account token, and more specifically, a funding wallet. Under this scenario, it can be determined that the transaction is a card unload. One example of such a transaction is the use of a prepaid card. For instance, OpenTable, Inc., may issue prepaid cards that can be used across a number of different restaurants within its network. When a consumer who's been issued one of these cards spends it at a restaurant, those funds are transferred from a prepaid card to a funding wallet. The funds residing in the funding wallet can subsequently be disbursed to the restaurant at which the consumer dined.

In some instances, an amount may be specified in the call. For example, if the card has a $50 balance, but the diner only spent $40 on the meal, then the call would include an amount of $40. In this instance, no currency exchange is necessary; however, if the prepaid card were to be issued in a different currency than the establishment at which it was accepted, an exchange would also need to occur, and would be reflected in the response. If the meal amount exceeded that of the $50 balance, the call could either indicate the maximum amount allowable, or it could not indicate an amount at all. As long as the amount indicated doesn't exceed the balance, then no issues would arise. Furthermore, if an amount is not indicated, then a full card balance unload is initiated. While the default rules may be set for a full card balance unload in the absence of an indicated amount, these rules can be altered, if necessary, to engage in a different process. For example, the response could potentially return an error that asks for an amount to be specified.

### Example 2—Direct Debit

When a call includes transfer method source token corresponding to a bank account, and a destination account token that corresponds to a merchant wallet, the system determines that a direct debit transaction is being initiated. In a direct debit, funds are pulled directly from a payee's bank account. As such, an authorization is required. An example of a direct debit transaction is when a client is authorized to put a hold on or collect funds from a renter's bank account to fulfill a damage deposit, e.g., for a vacation rental. These funds, when collected, first get pulled from the payee's bank account into the client's wallet, and then gets transferred into the client's merchant account.

In order to provide a proper call for a direct debit, at least one of a source or destination amount must be supplied along with the destination currency. In cases where the source currency matches that of the destination, no foreign exchange is required, but a fee may be applied. The transaction is then presented in the response as a simple transfer with an associated fee.

If two or more currencies are involved, then a foreign exchange is provided in the response quote along with any associated fees. For example, if the destination amount is $120 U.S. dollars (USD), but the source account holds only Great Britain pounds (GBP), then a currency conversion that takes into account foreign exchange rate is implicated. The details in the response quote will indicate this information. For example, to pay the $120 USD, the response quote will show a source amount of £93.82 with the currency being GBP. The response quote will also show an exchange rate of 0.78 and a fee, if applicable. The payment of the fees, whether it's by the client or the payee, will be determined based on set rules, and will be indicated in the quote.

While in this example call provides a destination amount and currency, other calls may use a combination of source and destination amount, and source and destination currency. As long as at least one of source and destination amount, and one of source and destination currency is supplied, the system can determine the rest.

### Example 3—External Account to External Account

Within a consumer wallet, a client may choose to pull funds from a prepaid card and cash it out to a bank account. Such a transaction, since it's a pull transaction, can only be performed upon authorization. A call with a transfer method source token and a transfer method destination token is specified to perform the external account to external account transfer. This type of transaction is traditionally performed through a user interface (UI), but can be executed over an API using the process described herein.

In an example, a balance of $227.04 Canadian dollar (CAD) is available on a prepaid card, and a client wishes to cash that amount out to an external bank account that holds USD. As indicated above, the call would need to include a transfer method source token and a transfer method destination token. If the call doesn't specify an amount for the cash out, then the process defaults to a full balance transfer. In other words, the entire $227.04 CAD amount will be quoted in the response for the transfer.

Since the destination account is in a different currency from the source, foreign exchange is implicated. Accordingly, the response quote will provide a destination amount along with the exchange rate on which the destination amount exchange was based. In this case, the destination amount would be $179.36 USD based on an exchange rate of 0.79. A fee may additionally be assessed.

If a source amount is indicated in the call (e.g., $100 CAD), then the response quote will include the source amount/currency, destination amount/currency, and the exchange rate. In this case, the source amount and currency is $100 CAD, as indicated by the call, and the destination amount and currency is $79.36 USD, as calculated by the 0.79 exchange rate. Additionally, a fee may be assessed to the receiving end bank account.

In an alternative use case, a destination amount may be specified. As long as the destination amount in USD does not exceed the source amount in CAD, a quote response will be returned. The quote will be constructed in much the same way as the example above where the source amount is provided, except that in this case, the source amount is calculated for the source currency using the specified exchange rate. So if the user wants $100 USD in the destination account, and a fee of $1.20 causes the transacted amount to be bumped up to $101.20 USD, a conversion at a rate of 0.79 would cause the source amount to be $128.10 CAD. If the destination amount in the call exceeds that which is available in the source account, an error may be returned in the response.

### Example 4—Wallet to External Account

To implicate a wallet to external account transaction, a call will include a user/consumer account source token and a transfer method destination token. This transaction may be a cash out from a wallet balance to a bank account. The cash out may be for a partial balance or for the entire amount. As discussed above with respect to external account to external account transactions, if neither a source nor a destination amount is specified, the transaction defaults to transferring the full amount. Thus, if the caller's motivation is to move then entire amount out of the wallet, then the caller can omit the amount field. If there are multiple currencies in the wallet, all of the amounts in their respective currencies will be transferred to the external bank account. However, if the external bank account is in USD, the non-USD currencies may be exchanged to USD before being disburse into the bank account.

If a partial balance cash out is requested, then the partial cash out will be transacted into the bank account based on the currency of the destination wallet. So if the currencies are different, a foreign exchange may be implicated. If multiple currencies are held in the source wallet, then a currency for the source must be specified in the call, or else a fault will be returned. If multiple currencies are held in the source wallet, and a destination currency and amount is specified for the destination wallet, then the transaction will first take from the same currency in the source wallet, and if not enough, will then exchange any foreign currency in the source wallet to account for the difference. If multiple foreign currencies are available when the currency specified for the destination is completely used up, then the caller may be pinged with and error to pick a currency. Alternatively, rules may be set up to exchange the additional currencies in a specific order. Additionally, if the source or destination amounts in the call is greater than a total of all source amounts across all currencies, then an error of insufficient funds will be returned.

In some embodiments, the specification of a currency that doesn't exist will trigger a code. For example, if the source wallet is in USD and a call requests a transfer with a destination currency of CAD, then a fault for invalid destination currency will be triggered. Errors are generally returned any time conflicting or insufficient information is provided. If certain information (e.g., source currency) is omitted from a call, and the omission may be resolved because there's only a single option for that particular piece of information (e.g., the destination wallet is in USD), then that omission may be considered inconsequential and the source currency will automatically be set to USD.

### Example 5—Wallet to Card

A wallet to card transaction is a prepaid card load from a wallet balance that's initiated by a call having a user source token and a transfer method prepaid card destination token. The rules by which this transaction is executed have been discussed in detail above (e.g., must supply a currency, if necessary; must have sufficient funds; must provide enough information so multiple options are not available, etc.). The call may specify one of a source or destination amount, and the currency logic is consistent with the ones described with respect to wallet to external account transactions.

### Example 6—Spendback

A spendback is a purchase that is made with a merchant (e.g., on a website), and the source of funds may be a prepaid card or a wallet balance. Spendback transactions are typically the result of a checkout that executes a transfer of a source of funds to a merchant directly. As such, the source token for a spendback may be either of a user token or a transfer method token. However, the destination token must be an account token, and typically, to a merchant wallet.

The spendback transfer is essentially the same using wallet funds or a prepaid card. Whether the spendback involves multiple currencies or not, a destination amount as well as a destination currency must be specified in the call. With that information, the system calculates a source amount. The source amount is calculated because, as discussed above, a merchant provides to a customer an amount that's owed for the transactions. In other words, a consumer cannot dictate what he would like to pay at checkout because that figure is fixed by the merchant. Consequently, if the intended transaction is a spendback, and a source amount is indicated by a consumer, then an error will be returned.

If multiple currencies are involved in a transaction, then a foreign exchange is implicated and the rules describe above are applied. For example, since the destination amount and currency are set, the system will calculate a source amount for the currency available, and provide that along with the exchange rate in the response quote. A fee may also be applied, and that fee is typically charged to the destination account, which is the merchant wallet in this case.

In some embodiments, a reverse transfer token may be used to undo a previously executed transaction. The reverse transfer token may be used as a response to a transfer endpoint post call. For example, when a post call is made, a transfer token is received back from the system, providing an indication of the of the transaction that was just executed. Using that transfer token, the reverse transfer token may simply inform the system that the call is a reversal of that previous call.

In one example, a reverse of a spendback may be initiated with the reverse token. In a spendback reverse, the funds are sourced from a merchant wallet and disbursed to a payee (i.e., the payee that sent funds to the merchant wallet in a previous transaction). The reversal are client functions, meaning that they must be initiated by the client, and not the payee. A spendback reverse is the only type of transaction where funding originates from a merchant wallet. Typically, when a merchant is to spend funds, funds are transferred from the merchant wallet to the a funding wallet, and then disbursed from the funding wallet. Referring back to the direct sales model, a spendback reverse may be a transaction where a payee who transferred funds back to the merchant to acquire additional products to sell wishes to return those products for a refund. In this situation, the spendback is reversed and the payee receives back the funds paid for the product.

In some embodiments, a payment endpoint may be provided so a client can make payment to payee. The client may choose transfer endpoint to transfer funds from funding wallet to a consumer wallet. A debit adjustment is a reverse of this transaction. Essentially, a debit adjustment is a reverse load, where money is taken from the customer wallet and disbursed back to a merchant funding wallet. As such, this transaction is a reverse of the payment transaction via the payment endpoint.

In some embodiments, a 400 error issued by an API may be manipulated to not show the error in the response, but to provide some context as to why the error occurred, whether it's insufficient funds, the caller needs to specify a currency, etc. There are set rules define how transfers are transacted, and if any of the rules are broken, the system provides some amount of context to the caller so that the error may be fixed.

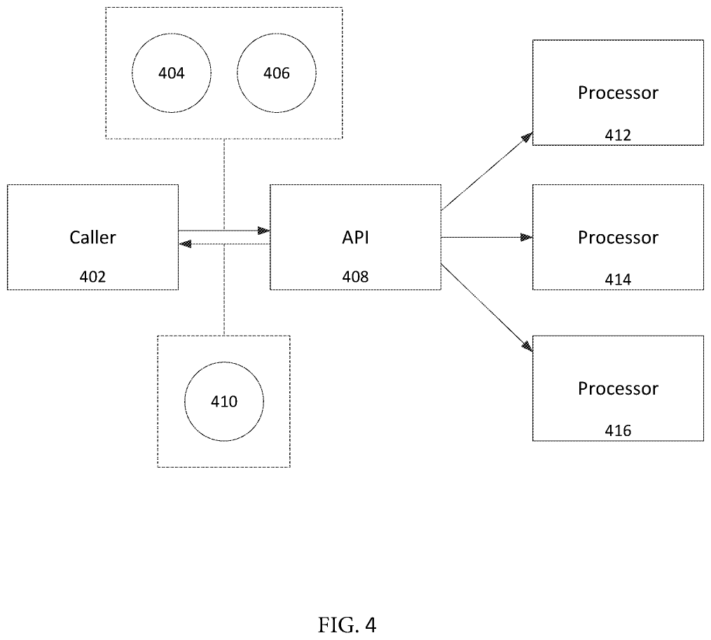

FIG. 4 provides a graphical depiction of a transfer endpoint API that orchestrates instructions between a caller and multiple processors. A caller 402 may make a call that includes a source token 404 and a destination token 406. As indicated above, the API 408 may determine an intention of the caller 402 based on the tokens 404 and 406. Once determined, the API 408 may return a response quote 410 to the caller 402 for confirmation. The response quote includes additional details about the transaction (e.g., amount being transacted, foreign exchange implications, etc.). In some instances, the response quote 410 may return an error if the information provided by the caller 402 is inconsistent with the intentions deciphered from the tokens.

Once the caller has received the response quote 410, the caller can book the transaction by confirming the details. The state of the transaction is changed to scheduled as the API passes instructions on to the appropriate processors 412-416 for handling the specific transaction. Once a transaction is complete, a webhook provides information back to the caller indicating the completion.

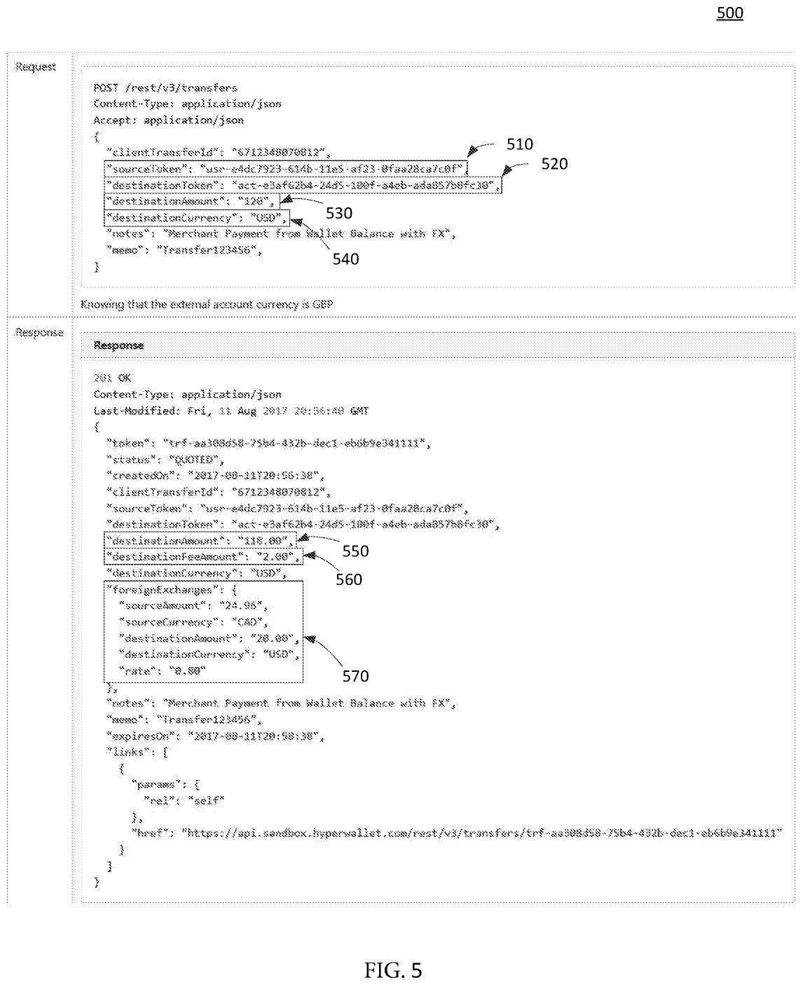

FIG. 5 provides a breakdown of the components of a request call and a corresponding response quote. The transaction depicted is a spendback that implicates a foreign exchange because of the use of two different currencies. In this example, the wallet has a balance of $100 USD and $100 CAD.

The source token 510 for this request call is a user token as indicated by the first three characters of “usr” of the token. The destination token 520, on the other hand, is an account token, as also indicated by the first three characters of “act” of the token. In this example, the call specifies a destination amount 530 as well as a destination currency 540.

With this information, the system can calculate a source amount. The destination amount 530 of $120 USD exceeds the amount of USD that's available in the wallet, i.e., $100 USD. As such, the call implicates a foreign exchange. As shown in the response, the actual destination amount 550 is reduced to $118 because a $2 fee 560 is being charged to the merchant. The foreign exchange component shows that in order to get to an additional $20 USD, $24.96 CAD must be exchanged at a rate of 0.80. Once this is calculated, the response quote is returned to the caller for booking. Upon confirmation by the caller, the transaction is scheduled based on the details provided in the response quote, which is to transfer $100 USD and $24.96 CAD, with $2 USD of that transaction covering the imposed fee.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “exemplary” is used herein to mean “serving as an example, instance, or illustration.” Any implementation described herein as “exemplary” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system for controlling an application programming interface (API) endpoint for transferring funds comprising:
a non-transitory memory storing instructions; and
one or more hardware processors coupled to the non-transitory memory and configured to read the instructions from the non-transitory memory to cause the system to perform operations comprising:
receiving, from a caller, a call including a source token and a destination token;
identifying a first type of token and a first type of wallet corresponding to the source token, and a second type of token and a second type of wallet corresponding to the destination token;
determining, based on the first type of token, the first type of wallet, the second type of token, and the second type of wallet, a corresponding transaction; and
sending, to the caller, a response quote including details about the transaction and a request for confirmation.

2. The system of claim 1, wherein the call further includes at least one of a source amount and a source currency or a destination amount and a destination currency.

3. The system of claim 2, wherein the operations further comprise determining, based on the source currency and destination currency, that a foreign exchange conversion is implicated, wherein the details about the transaction included in the response quote includes information about a proposed currency conversion and the conversion rate.

4. The system of claim 2, wherein a validation is performed based on the determined transaction and the inclusion of at least one of the source amount and the source currency or the destination amount and the destination currency.

5. The system of claim 1, wherein each of the first type of token and the second type of token is one of a user token, an account token, and a transfer method token.

6. The system of claim 5, wherein the user token corresponds to a consumer wallet.

7. The system of claim 5, wherein the account token corresponds to one of a funding wallet, a merchant wallet and a pending wallet.

8. The system of claim 5, wherein the transfer method wallet corresponds to one of an external bank account and a prepaid card.

9. The system of claim 1, wherein the operations further comprise providing a predetermined amount of time for a receipt of a confirmation to the response quote, wherein the response quote is cleaned up when no confirmation to the response quote is received within the predetermined amount of time, and wherein the transaction is scheduled when a confirmation to the response quote is received within the predetermined amount of time.

10. The system of claim 1, wherein the transactions include a card unload, a direct debit, a first external account to a second external account transfer, a wallet to external account transfer, a wallet to prepaid card transfer, and a spendback.

11. A method for controlling an API endpoint for transferring funds comprising:
receiving, from a caller, a call including a source token and a destination token, and at least one of a source amount and a source currency or a destination amount and a destination currency;
identifying a first type of token and a first type of wallet corresponding to the source token, and a second type of token and a second type of wallet corresponding to the destination token;
determining, based on the first type of token, the first type of wallet, the second type of token, and the second type of wallet, a corresponding transaction;
performing a validation based the transaction and the at least one of the source amount and the source currency or the destination amount and the destination currency; and
sending, to the caller, a response quote including details about the transaction and a request for confirmation.

12. The method of claim 11, further comprising determining, based on the source currency and destination currency, that a foreign exchange conversion is implicated, wherein the details about the transaction included in the response quote includes information about a proposed currency conversion and the conversion rate.

13. The method of claim 11, wherein the response quote further includes a fee and an indication of the payor of the fee.

14. The method of claim 11, wherein each of the first type of token and the second type of token is one of a user token, an account token, and a transfer method token.

15. The method of claim 14, wherein the user token corresponds to a consumer wallet, wherein the account token corresponds to one of a funding wallet, a merchant wallet and a pending wallet, and wherein the transfer method wallet corresponds to one of an external bank account and a prepaid card.

16. The method of claim 11, further comprising providing a predetermined amount of time for a receipt of a confirmation to the response quote, wherein the response quote is cleaned up when no confirmation to the response quote is received within the predetermined amount of time, and wherein the transaction is scheduled when a confirmation to the response quote is received within the predetermined amount of time.

17. The method of claim 11, wherein the transactions include a card unload, a direct debit, a first external account to a second external account transfer, a wallet to external account transfer, a wallet to prepaid card transfer, and a spendback.

18. A non-transitory machine-readable medium having stored thereon machine-readable instructions executable to cause performance of operations comprising:
receiving, from a caller, a call including a source token and a destination token, and at least one of a source amount and a source currency or a destination amount and a destination currency;
identifying a first type of token and a first type of wallet corresponding to the source token, and a second type of token and a second type of wallet corresponding to the destination token;
determining, based on the first type of token, the first type of wallet, the second type of token, and the second type of wallet, a corresponding transaction;
performing a validation based the transaction and the at least one of the source amount and the source currency or the destination amount and the destination currency; and
sending, to the caller, a response quote including details about the transaction and a request for confirmation.

19. The non-transitory machine-readable medium of claim 18, wherein:
each of the first type of token and the second type of token is one of a user token, an account token, and a transfer method token;
the user token corresponds to a consumer wallet,
the account token corresponds to one of a funding wallet, a merchant wallet and a pending wallet; and
the transfer method wallet corresponds to one of an external bank account and a prepaid card.

20. The non-transitory machine-readable medium of claim 18, wherein the transactions include a card unload, a direct debit, a first external account to a second external account transfer, a wallet to external account transfer, a wallet to prepaid card transfer, and a spendback.
